(19) United States
(12) Patent Application Publication
(10) Pub. No.: US 2009/0113220 A1
(43) Pub. Date: Apr. 30, 2009

(54) ENCRYPTED BACKUP DATA STORAGE DEVICE AND STORAGE SYSTEM USING THE SAME

(76) Inventors: Sang Han LEE, Daejeon (KR); Hae Yong YANG, Daejeon (KR); Tae Joo CHANG, Daejeon (KR); Choon Soo KIM, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/257,594

(22) Filed: Oct. 24, 2008

(30) Foreign Application Priority Data
Oct. 26, 2007 (KR) 10-2007-0108388
Jul. 8, 2008 (KR) 10-2008-0065792

(51) Int. Cl. G06F 21/00; H04L 9/00

(52) U.S. Cl. 713/193

(57) ABSTRACT

An encrypted backup data storage device and a storage system using the same are provided. A backup memory stores at least one of plain-text data and a secret key. A leakage current blocking circuit includes at least one inverter and a complementary metal oxide semiconductor (CMOS) NAND gate circuit and cuts off leakage current paths formed by the lines connected to the battery backup memory.

### CROSS-REFERENCE TO RELATED APPLICATION

This application claims priority to and the benefit of Korean Patent Application Nos. 2007-108388, filed Oct. 26, 2007 and 2008-65792, filed Jul. 8, 2008, the disclosures of which are incorporated herein by reference in their entirety.

### BACKGROUND

1. Field of the Invention

The present invention relates to an encrypted backup data storage device and a storage system using the same. More particularly, the present invention relates to an encrypted backup data storage device that includes a System on chip (SoC)-type device to safely store a secret key of encrypted backup data and a storage system using the same.

2. Discussion of Related Art

A backup data storage device is a device that can maintain data using power supplied by an internal battery when external power is interrupted. The backup data storage device is widely used to maintain system operation status in mobile phones or portable terminals such as personal digital assistants (PDA). etc. and safely store secret data in a cryptographic system having a physical attack protection function. In particular, an encrypted backup data storage system should consume a small amount of power to maintain data for a long time. For this, a low power memory, which is developed with a transistor level design technique dedicated to reduce power consumption, is generally applied for the data backup memory.

FIG. 1 shows a configuration of a conventional encrypted backup data storage system for storing secret data.

Referring to FIG. 1, the encrypted backup data storage system having a physical attack protection mechanism includes a backup memory 100 for storing secret data, a power controller 103 and a battery 105 for continuously supplying power to the backup memory 100 and an attack sensor 109, a protection cover 107 for covering the system, the attack sensor 109 for sensing an external physical attack, and a power blocking circuit 101 for interrupting the supply power of the backup memory 100 (V_{SRAM}) when an attack sensing signal is generated. The encrypted backup data storage system may further include a cryptographic unit 111. The cryptographic unit 111 encrypts data stored in the backup memory 100 and communicates with an external device by including a central processing unit (CPU), a memory, a cryptographic chip, and an external interface.

When a physical attack of opening or puncturing the protection cover 107 occurs in the encrypted backup data storage system, the attack sensor 109 senses the attack and outputs the attack sensing signal to the power blocking circuit 101. When the attack sensing signal is detected, the power blocking circuit 101 switches the supply power of the backup memory 100 (V_{SRAM}) to ground, such that data stored in the backup memory 100 is deleted.

Many SRAM devices used for the backup memory has a characteristic of maintaining stored data for a given time without any power when a surrounding temperature is several tens of degrees Celsius below zero. Accordingly, the cryptographic system of FIG. 1 is subject to a low temperature attack using such a characteristic. There may be various methods of disabling the attack sensor 109 located in the cryptographic system of FIG. 1. When the attack sensor 109 is disabled, the protection cover may be opened while power is supplied to the backup memory 100. In this case, the secret data may be disclosed by probing data signals, since data bus of the memory is directly exposed. Even when the cryptographic unit 111 for encrypting plain-text data stored in the backup memory 100 is further included, there is a possibility of physical exposure since the backup memory 100 and the cryptographic unit 111 are physically separated and the data transferred between them is plain-text data.

### SUMMARY OF THE INVENTION

The present invention provides an encrypted backup data storage device and a storage system using the same.

The present invention also provides an encrypted backup data storage device that can provide robust protection mechanism for secret data against various physical attacks by integrating a cryptographic unit and a backup memory into a single chip using SoC technology and a storage system using the same.

The present invention also provides an encrypted backup data storage device that can be manufactured with a standard-cell based design technique to be embedded into a SoC without an additional process for a low-power memory and can operate at low power and a storage system using the same.

In one aspect, the invention provides an encrypted backup data storage device, which includes a backup memory that stores at least one of plain-text data and a secret key; and a leakage current blocking circuit that includes at least one inverter and a complementary metal oxide semiconductor (CMOS) NAND gate circuit and blocks a leakage current of a line connected to the backup memory.

The encrypted backup data storage device may further include: a cryptographic unit that encrypts the plain-text data stored in the backup memory and decrypts data received from an external device. The encrypted backup data storage device may further include: a power separation barrier that electrically isolates a power supply pin for supplying the backup memory with power.

The backup memory may be compiled using a memory compiler, which is kind of design automation software provided by a semiconductor company. The backup memory may store encrypted data or a secret key for encryption. The leakage current blocking circuit may block the leakage current using operation characteristics of the CMOS NAND gate circuit and stabilize a signal to be output to the backup memory during power switching.

In another aspect, the invention provides an encrypted backup data storage system, which includes a backup data storage device including a backup memory that stores at least one of plain-text data and a secret key and a leakage current blocking circuit that includes at least one inverter and a CMOS NAND gate circuit and blocks a leakage current caused by signal lines connected to the backup memory; a power controller that switches power to be supplied to the backup data storage device; and an attack sensor that outputs a power switching signal to the power controller by sensing a physical attack to the backup data storage device.

The encrypted backup data storage system may further include: a battery, connected to the power controller, which supplies the backup data storage device with the power. The power controller may select power for the backup data storage device from battery and external supply power, switch the power to be supplied to the backup data storage device, and output a power switching signal corresponding to power switching. The encrypted backup data storage system may further include: a protection cover that covers an outer portion of the backup data storage device and senses physical attacks. The encrypted backup data storage system may further include: an extended memory, located outside the backup data storage device, which stores secret data encrypted with the secret key.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 shows a configuration of a conventional encrypted backup data storage system for storing secret data;

FIG. 2 is a schematic diagram showing an encrypted backup data storage system according to an exemplary embodiment of the present invention;

FIG. 3 shows details of a backup memory unit of a backup data storage device according to an exemplary embodiment of the present invention;

FIG. 4 shows details of a leakage current blocking circuit according to an exemplary embodiment of the present invention;

FIG. 5 is a schematic diagram for explaining a current blocking theory of the leakage current blocking circuit using a transistor level circuit of a CMOS NAND gate;

FIG. 6 shows an exemplary embodiment of a power separation barrier; and

FIG. 7 is a schematic diagram showing a cryptographic system using the backup data storage device according to an exemplary embodiment of the present invention.

### DETAILED DESCRIPTION OF EXEMPLARY EMBODIMENTS

Hereinafter, an encrypted backup data storage device and a storage system using the same according to exemplary embodiments of the present invention will be described with reference to the accompanying drawings.

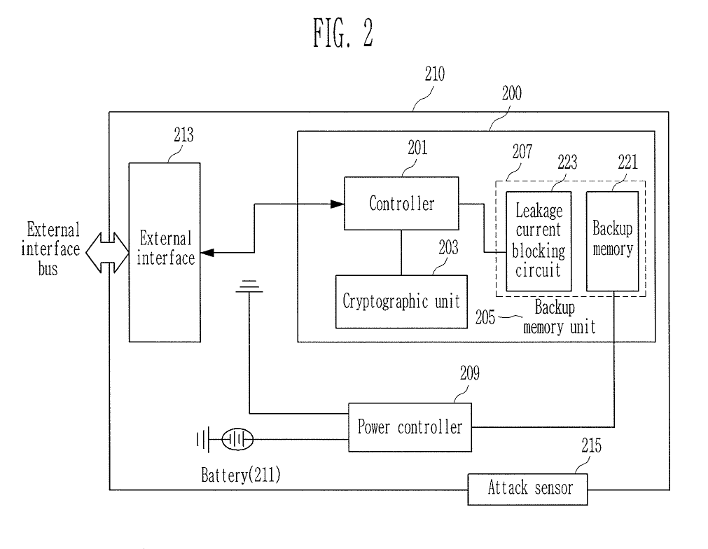

FIG. 2 is a schematic diagram showing an encrypted backup data storage according to an exemplary embodiment of the present invention.

Referring to FIG. 2, the encrypted backup data storage according to the exemplary embodiment of the present invention includes a backup data storage device 200, an external interface 213, a battery 211, a power controller 209, an attack sensor 215, and a protection cover 210.

In particular, the backup data storage device 200 includes a controller 201, a cryptographic unit 203, a backup memory 221, and a leakage current blocking circuit 223. A combination of the backup memory 221 and the leakage current blocking circuit 223 is referred to as a backup memory unit 205.

The backup data storage device 200 is implemented as a single semiconductor chip including the controller 201, the cryptographic unit 203, the backup memory 221, and the leakage current blocking circuit 223. It can be implemented using the SoC process. In particular, the backup data storage device 200 can be manufactured on the basis of a standard cell corresponding to a general SoC manufacturing method without use of a special process for low-power consumption. Since there is no additional cost and process for the backup data storage device, mass production is possible with simple and cost-effective method.

Unlike the conventional backup memory such as a backup static random access memory (SRAM), the backup data storage device 200 outputs secret data only after encrypting with a semiconductor chip, thereby it can provide a powerful physical protection mechanism against various physical attacks.

The external interface 213 transmits an encrypted signal from the backup data storage device 200 to an external device.

The battery 211 supplies power to the backup data storage device to allow it to store data, even when the external power is not supplied.

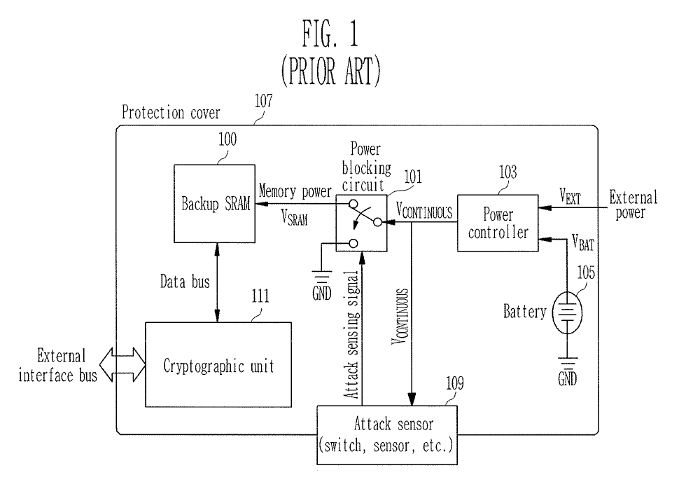

The power controller 209 switches the supply power of the backup memory 221 to the battery power, when the external power is not supplied. When an external attack sensing signal is received from the attack sensor 215, the power controller 209 may erase memory content by grounding the supply power for the backup memory 221. The power controller 209 can be a combination of the power blocking circuit 101 and the power controller 103 of FIG. 1.

When an external physical attack to the encrypted backup data storage system occurs, the attack sensor 215 senses the attack and reports the sensed attack to the power controller 209. The attack sensor 215 senses an attempt to remove or puncture the protection cover 210 covering the encrypted backup data storage system.

The protection cover 210 covers the encrypted backup data storage system. The protection cover 210 protects the encrypted backup data storage system and reports a physical intrusion to the attack sensor 215.

The backup data storage device 200 is implemented as a single semiconductor chip including the controller 201, the cryptographic unit 203, the backup memory 221, and the leakage current blocking circuit 223 using the SoC process. The controller 201 controls an overall operation of the backup data storage device 200.

When an amount of encrypted data to be stored in the backup memory 221 is large, the large amount of data can be stored in the external nonvolatile memory. And the backup memory 221 stores only a secret key used for the encryption process. In this case, the controller 201 can decrypt the data stored in the nonvolatile memory using cryptographic unit and the secret key stored in the backup memory 221.

Under control of the controller 201, the cryptographic unit 203 encrypts plain-text data stored in the backup memory 221 and the external nonvolatile memory or decrypts the encrypted data into plain-text data.

The backup memory 221 can be a compiled memory produced by an electronic design automation program as a memory located inside the backup data storage device 200. That is, a special design method is used to reduce power consumption in a conventional memory, but the backup memory 221 according to an exemplary embodiment of the present invention directly uses a memory based on the general SoC design method. As compared to the conventional memory, the memory according to the exemplary embodiment of the present invention can be produced cost-effectively and simply without any special process.

To eliminate unnecessary power consumption, a power separation barrier 207 and a leakage current blocking circuit 223 are further provided.

The power separation barrier 207 and the leakage current blocking circuit 223 will be described in detail with reference to the following drawings.

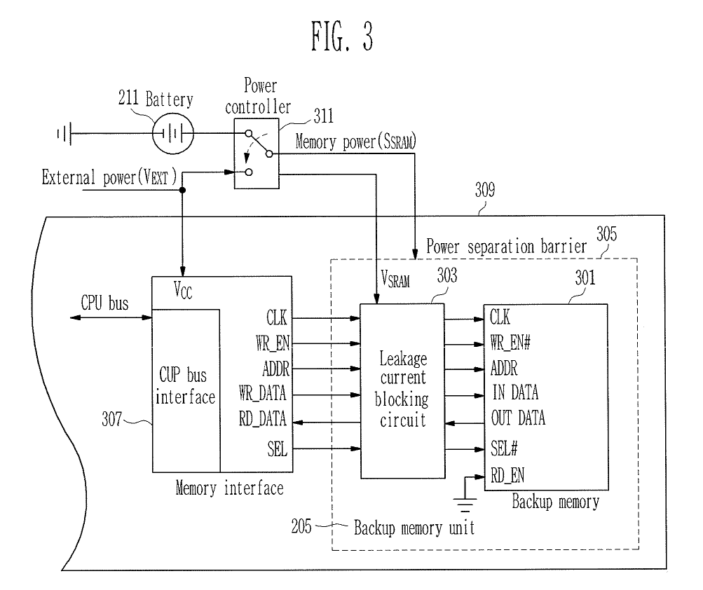

FIG. 3 shows details of the backup memory unit of the backup data storage device according to an exemplary embodiment of the present invention.

Referring to FIG. 3, the backup memory unit 205 within the backup data storage device 200 includes a leakage current blocking circuit 303 and a backup memory 301.

As described in FIG. 2, the backup memory 301 is a memory generated by the electronic design automation program in general SoC design flow. This memory is produced using a memory compiler, a kind of electronic design automation program provided by a semiconductor manufacturer. In general, current consumption of the backup memory 301 is proportional to the memory capacity. When the memory capacity increases, the current consumption for storing data in the backup memory 301 increases. In the present invention, the semiconductor manufacturing process or the memory compiling process for producing the backup memory is not specially limited. However, since the current consumption of the backup memory is proportional to the memory capacity, the capacity can be selected to meet a target battery lifetime, in consideration of a battery capacity, a data storage period, and the relationship between the current consumption and the memory capacity. When an amount of data to be stored is large, a large amount of backup data can be stored in an external memory after encrypting, and only a secret key for decrypting data stored in the external memory can be stored in the backup memory.

The leakage current blocking circuit 303 blocks a leakage current through a signal line communicating with a memory interface 307 and enables data to be stably stored even when the external power V_{EXT} is interrupted.

Here, the leakage current blocking circuit 303 interrupts the above-mentioned leakage current using operation characteristics of a CMOS NAND gate as described with reference to the following drawings and enables data to be stably stored even when the power to be supplied for the backup memory 301 is changed.

That is, even when the external power V_{EXT}, is interrupted, the backup memory unit 205 can continuously receive battery power under the control of the power controller 311. However, the remaining elements in the SoC 200 can not receive the power. In this state, memory access control signals CLK, WR_EN, and SEL output from the memory interface 307 may be temporarily placed in an unstable state. In this case, data stored in the backup memory 301 may be damaged. The leakage current blocking circuit 303 of FIG. 3 prevents data from being damaged during a transition time of power to be supplied.

When the external power V_{EXT} is interrupted and a signal RET_MODE of a power controller 311 is activated, the leakage current blocking circuit 303 is responsible for enabling data to be safely stored by deactivating all control signals CLK, WR_EN, and SEL to be transferred to the backup memory 301 and preventing access to the backup memory 301.

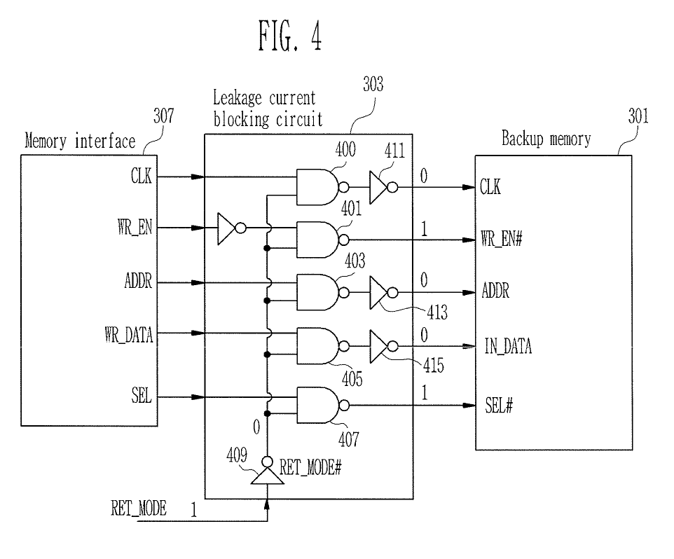

FIG. 4 shows details of the leakage current blocking circuit according to an exemplary embodiment of the present invention.

Referring to FIG. 4, the leakage current blocking circuit 303 includes NAND gates 400, 401, 403, 405, and 407 and inverters 409, 411, 413, and 415. In FIG. 3, when the external power is interrupted, the signal RET_MODE output from the power controller 311 becomes 1 (high). Upon receipt of the signal RET_MODE, the input inverter 409 generates a signal RET_MODE# (where # indicates an inverted signal) by inverting the input signal. When the signal RET_MODE# passes through the NAND gates 400, 401, 403, 405, and 407, control signals input to the backup memory 301 are deactivated regardless of signals transmitted from the memory interface (for example, CLK=0, WR_EN#=1, and SEL#=1). Accordingly, the leakage current blocking circuit 303 prevents an unstable access control signal while the external power is interrupted, such that data can be stably stored in the memory.

The leakage current blocking circuit 303 can be normally connected to the backup memory 301 in a state in which the external power is applied. In a normal operating state in which the external power is applied, the power controller 311 outputs the signal RET_MODE as 0 (low). Accordingly, the internal signal RET_MODE# of the leakage current blocking circuit becomes 1 (high). When the signal RET_MODE# is input, the NAND gates can output signals received from the memory interface and hence the control signals can be appropriately transferred to the backup memory 301.

When the external power V_{EXT} is interrupted in FIG. 3, signals of the memory interface to which power is not supplied and signals of the backup memory 301 to which power is continuously supplied from the battery 211 have different voltage levels. Therefore, a leakage current flows through signal lines between the memory interface 307 and the backup memory 301. The leakage current blocking circuit 303 prevents the leakage current using operation characteristics of a CMOS NAND gate applied to the leakage current blocking circuit 303.

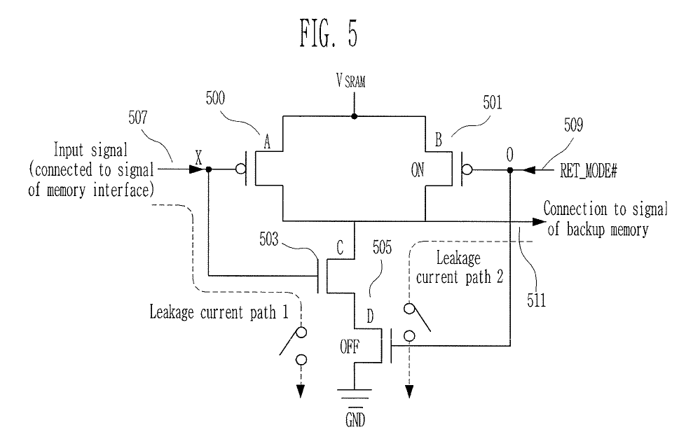

FIG. 5 is a schematic diagram for explaining a current blocking theory of the leakage current blocking circuit using a transistor level circuit of a CMOS NAND gate.

Referring to FIG. 5, an input signal 507 of a transistor-A 500 of the CMOS NAND gate is coupled to a signal of the memory interface, an input 509 of a transistor-B 501 is coupled to the signal RET-MODE#, and an output signal 511 of the NAND gate is coupled to a signal of the backup memory. When the external power V_{EXT} is interrupted in FIG. 5, the signal RET_MODE# becomes 0, the transistor-B 501 is turned on, and a transistor-D 505 is turned off. In this case, both a leakage current path 1 between the input signal 507 of the NAND gate and the ground and a leakage current path 2 between the output signal 511 of the NAND gate and the ground are cut off. As shown in FIG. 4, the leakage current blocking circuit 303 receives all control signals output from the memory interface 307 and the signal RET_MODE# and generates signals to be output to the backup memory through the CMOS NAND gates 400, 401, 403, 405, and 407. Therefore, all the leakage current paths by the signal lines connected to the backup memory are cut off by the above-described CMOS NAND gate characteristics.

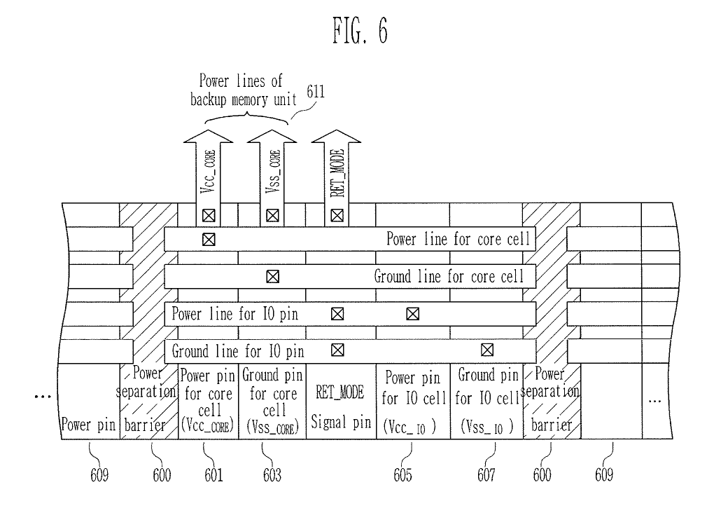

FIG. 6 shows an exemplary embodiment of a power separation barrier.

A power separation barrier 305 interrupts a current leaked through a power line inside the SoC. In general, multiple power pins for supplying power are assigned to the SoC. In the SoC, the power pins are mutually connected through power lines. As seen from FIG. 3, a power line of the backup memory unit 205 to receive power from the battery and a power line of the other circuit within a SoC 309 have different voltage levels when the external power V_{EXT} is turned off, such that the leakage current occurs through the power line. The power separation barrier 305 cuts off the leakage current paths formed by power lines by separating the power of the backup memory unit 205 and the other power within the SoC 309.

FIG. 6 shows an example of a power separation method of the power separation barrier. In general, power pins of the SoC configured with only a digital circuit are a power pin for a core cell, a ground pin for the core cell, a power pin for an input/output (IO) cell, and a ground pin for the IO cell. As shown in the example of FIG. 6, power pins 601, 603, 605, and 607 for a backup SRAM 205 are separated from the other power pins 609 of the SoC by a power separation barrier 600.

A leakage current due to a voltage level difference is cut off by physically separating the power pins 601, 603, 605, and 607 from the other power pins 609 of the SoC.

The power separation barrier 600 may be provided in the form of a slot cell library in a cell-based semiconductor design process and is used when circuits such as a phase locked loop (PLL), real time clock (RTC), etc. requiring separate power are embedded into the SoC. The present invention has no limit on the library or semiconductor process for the power separation barrier 600.

To prevent a current from being leaked through the power lines within the SoC 305, a physically separated power line is provided for the backup memory unit 205. To separate the power, the power separation barrier 600 is inserted between the backup memory unit 205 and the other circuit.

According to the exemplary embodiment of the present invention, the backup memory can be implemented with low cost, because it can be implemented with cell-based design methodology that is generally applied to a SoC developing technique, and it requires no additional manufacturing process dedicated to reduce power consumption. In particular, the physical security strength of the cryptographic system can be enhanced when the backup memory unit 205 is embedded into the SoC in which encryption is possible and applicable to the cryptographic system having the physical attack protection mechanism as described with reference to FIG. 2.

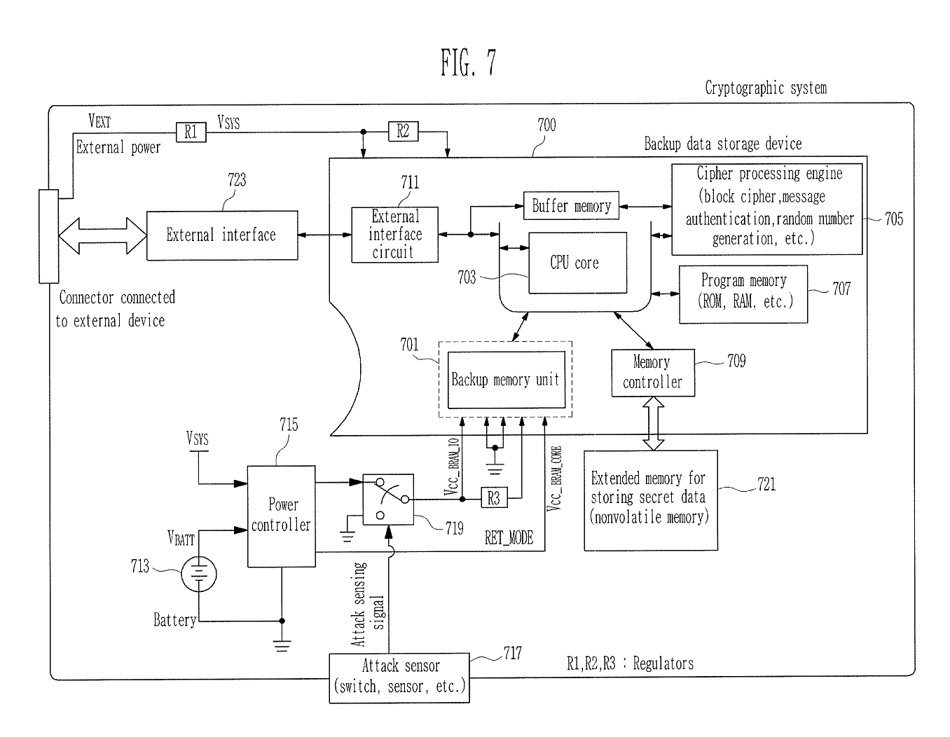

FIG. 7 is a schematic diagram showing a cryptographic system using the backup data storage device according to an exemplary embodiment of the present invention.

Referring to FIG. 7, a backup data storage device 700 of this embodiment includes a backup memory unit 701, a CPU core 703 for controlling an overall operation of the cryptographic system and performing various security service functions provided in the cryptographic system, a cipher processing engine 705 configured with a block cipher processing engine, a message authentication code (MAC) processing engine, a random number generator, etc., a program memory 707 for storing programs, such as a ROM, SRAM, etc., a memory controller 709 for interfacing with an extended memory that stores secret data, an external interface circuit 711 for providing a standard interface functions, such as the peripheral component interconnect (PCI) and the universal serial bus (USB), outside the cryptographic system through an external interface 723, etc. The present invention is not limited to a type of CPU core, a memory size, and a type of standard interface function that is provided by the external interface circuit 711 and the external interface 723. These elements can be variously configured according to application fields of the cryptographic system. The cipher processing engine can also have additional configurations such as a public key cipher processing engine, a Hash processing engine, a stream cipher processing engine, etc. in addition to the above process engines. According to an exemplary embodiment of the present invention, the backup data storage device 700 can include the backup memory unit 701, the CPU core 702, the cipher processing engine 705, the program memory 707, the memory controller 709, and the external interface circuit 711. The cipher processing engine 705 can include the block cipher processing engine, the MAC processing engine, the random number generator, etc.

As shown in FIG. 7, the cryptographic system according to an exemplary embodiment of the present invention includes a battery 713 for continuously supplying power to the backup memory unit 701, an attack sensor 717, and a power blocking circuit 719, a power controller 715 for switching power to be supplied to the backup memory unit 701 to battery power when external power V_{EXT} is interrupted and activating a signal RET_MODE, the attack sensor 717 for sensing a physical attack, the power blocking circuit 719 for blocking power voltages V_{CC}_{_{—}}_{BRAM}_{_{—}}_{IO} and V_{CC}_{_{—}}_{BRAM}_{_{—}}_{CORE} to be supplied to the backup memory unit 701 when the attack sensor 717 activates an attack sensing signal, an extended memory 721 for storing various secret data of the cryptographic system, that is encrypted by cipher processing engine 705 within the backup data storage device 700, and the external interface 723 for providing standard interface functions for a PCI, USB, etc. connected to a device outside the cryptographic system in addition to the backup data storage device 700. The cryptographic system can further include regulators R1, R2, and R3 for regulating the external power V_{EXT} to voltages V_{SYS}, V_{CC}_{_{—}}_{BRAM}_{_{—}}_{IO}, and V_{CC}_{_{—}}_{BRAM}_{_{—}}_{CORE} required for the elements therein.

The cryptographic system having the configuration as described above can store and manage plain-text data only within the backup data storage device 700 and encrypt and store secret data to be stored outside the backup data storage device 700.

Memories capable of storing secret data in the cryptographic system can be an internal memory of the backup memory unit 701 of the backup data storage device 700 and the extended memory 721. Since the internal memory of the backup memory unit 701 may not have a large capacity due to limited power consumption, it is suitable to store small-sized secret data of the cryptographic system, for example, a key for encrypting secret data and a MAC value for integrity verification. The extended memory 721 for storing secret data as a nonvolatile memory can have a larger capacity than the internal backup memory unit 701 and can be additionally used for storing secret data after encrypting it. The extended memory 721 can store relatively large-sized secret data such as an operating program of the cryptographic system, a certificate, a pair of a secret key and a private key for a digital signature and other user data to be protected.

According to an exemplary embodiment of the present invention, the cryptographic system encrypts and stores data in the extended memory 721 for storing secret data. After encrypted secret data is decrypted in booting and operating processes of the system, the decrypted data is loaded and used in the internal memory of the backup data storage device.

That is, when the backup data storage device 700 receives secret data such as an operating program, a certificate, and a pair of a secret key and a private key for a digital signature from an outside source and stores the secret data internally, secret keys for cipher processing are generated using the internal random number generator 705 and the secret data is encrypted using an encryption/decryption key of the secret keys and the block cipher processing engine 705. When the integrity of secret data is to be verified, a MAC value for the secret data is generated using a MAC key of the secret keys and the MAC processing engine 705. The secret keys and the MAC value generated as described above are stored in the internal memory of the backup memory unit 701 within the chip. The encrypted secret data is stored in the extended memory 721 outside the chip. In the encryption and storage processes as described above, the CPU core 703 of the backup data storage device 700 controls the series of processing operations to be performed only in the program memory 707 within the chip and controls all secret data to be externally output only in the encrypted form.

After the encrypted data stored in the extended memory 721 is decrypted in an operating process of the cryptographic system of FIG. 7, the decrypted data is managed only in the program memory 707 within the chip. That is, the backup data storage device 700 reads the encrypted data, decrypts the read encrypted data using the block cipher processing engine 705 and the encryption/decryption key of the backup memory unit 701 used in the encryption process, and loads and uses the decrypted data in the program memory 707 within the backup data storage device 700. As needed, a message authentication operation can be performed. In this process, the backup data storage device 700 computes a MAC value for the decrypted secret data using the MAC processing engine 705 and the MAC key stored in the internal memory of the backup memory unit 701, and compares the computed MAC value to a MAC value stored in the backup memory unit 701.

When the message authentication fails in the above process, the cryptographic system can stop its execution or a system supported function by outputting an error message. In the decryption and loading processes like the encryption and storage processes, the CPU core 703 within the chip controls the above-described series of operations to be performed only in the internal memory 707 within the chip.

The secret data can be protected from malicious modification such as malicious code insertion for leaking secret data by adding a message authentication process for secret data stored outside the chip, as needed.

The cryptographic system using the backup data storage device 700 can provide more enhanced physical security than the conventional cryptographic system using the memory 100 of FIG. 1. This is because the data bus of the backup memory unit 701 embedded into the backup data storage device 700 of FIG. 7 is not directly exposed even when the cryptographic system is opened in a state in which data may be accessed by a low-temperature attack using a characteristic that memory data remains at a low temperature or by disabling the attack sensor. As described above, the cryptographic system of FIG. 7 can manage plain-text secret data only in the backup data storage device 700, store the encrypted secret data outside the chip, and safely store encryption keys in the backup memory unit 701 within the chip, thereby safely storing and managing all secret data of the cryptographic system.

According to exemplary embodiments of the present invention, an encrypted backup data storage device and a storage system using the same can be provided.

According to exemplary embodiments of the present invention, an encrypted backup data storage device and a storage system using the same can protect the secret data from an external physical attack by integrating a cryptographic unit and a backup memory into a single chip using SoC technology.

According to exemplary embodiments of the present invention, an encrypted backup data storage device and a storage system using the same can be manufactured on a standard cell basis to be embedded into an SoC without an additional process for a low-power memory and can operate at low power.

Although exemplary embodiments of the present invention have been disclosed for illustrative purposes, those skilled in the art will appreciate that various modifications, additions, and substitutions are possible, without departing from the scope of the present invention. Therefore, the present invention is not limited to the above-described embodiments, but is defined by the following claims, along with their full scope of equivalents.

What is claimed is:

1. An encrypted backup data storage device comprising:
a backup memory that stores at least one of plain-text data and a secret key; and
a leakage current blocking circuit that has at least one inverter and a CMOS NAND gate circuit and cuts off leakage current paths formed by the lines connected to the battery backup memory.

2. The encrypted backup data storage device of claim 1, wherein control and data signals are transmitted to the backup memory though the CMOS NAND gate circuit.

3. The encrypted backup data storage device of claim 1, further comprising:
a cryptographic unit that encrypts the plain-text data stored in the backup memory and decrypts data received from an external device.

4. The encrypted backup data storage device of claim 1, further comprising:
a power separation barrier that electrically isolates a power supply pin for supplying the backup memory with power.

5. The encrypted backup data storage device of claim 1, wherein the backup memory is compiled using a memory compiler, which is kind of design automation software provided by a semiconductor company.

6. The encrypted backup data storage device of claim 1, wherein the backup memory stores a secret key for encryption.

7. The encrypted backup data storage device of claim 1, wherein the leakage current blocking circuit blocks the leakage current using operation characteristics of the CMOS NAND gate circuit and stabilizes a signal to be output to the backup memory during power switching.

8. An encrypted backup data storage system comprising:
a backup data storage device including a backup memory that stores at least one of plain-text data and a secret key; and a leakage current blocking circuit that includes at least one inverter and a CMOS NAND gate circuit and cuts off leakage current paths formed by the lines connected to the battery backup memory;
a power controller that switches power to be supplied to the backup data storage device; and
an attack sensor that outputs a power switching signal to the power controller on sensing a physical attack to the backup data storage device.

9. The encrypted backup data storage system of claim 8, further comprising:
a battery, connected to the power controller, which supplies the backup data storage device with the power.

10. The encrypted backup data storage system of claim 8, wherein the power controller selects one of at least two supply powers to switch the power to be supplied to the backup data storage device and outputs a power switching signal corresponding to the power switching.

11. The encrypted backup data storage system of claim 8, further comprising:
a protection cover that covers the backup data storage device and senses a physical attack.

12. The encrypted backup data storage system of claim 8, further comprising:
an extended memory, located outside the backup data storage device, which stores data encrypted with the secret key.
